(19) United States
(12) Patent Application Publication
(10) Pub. No.: US 2008/0204881 A1
(43) Pub. Date: Aug. 28, 2008

(54) OPTICAL COUPLING SYSTEM AND AN OPTICAL ELEMENT

(75) Inventor: Evan Paul THRUSH, San Francisco, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 11/679,840

(22) Filed: Feb. 28, 2007

(51) Int. Cl. G02B 1/10

(52) U.S. Cl. 359/580

(57) ABSTRACT

An optical coupling system is disclosed. The optical coupling system includes a first optical element, a second optical element and a layer of an optically transmissive elastic material disposed between the first optical element and the second optical element. At least one of the first optical element and the second optical element has a surface facing the elastic layer that is non-planar across the surface. An optical element having the non-planar surface is also disclosed.

### BACKGROUND

In making optical measurements, it is often necessary to optically couple two optical elements together in such a way that there is little or no optical loss due to reflection or total internal reflection when light propagates from one to the other. An example of such an optical measurement is a surface plasmon resonance (SPR) measurement. In a typical SPR measurement system, two optical elements such as a prism and a slide must be optically coupled together. An optical coupling medium having a refractive index similar to the refractive indices of the two optical elements is used to effect this optical coupling. One such medium is immersion oil. The use of immersion oil can be messy, difficult and time consuming. These problems can be avoided by the use of a medium such as a solid elastic material or an optointerface plate having parallel ridges on both surfaces, both of which are disclosed in U.S. Pat. No. 5,164,589; Sjödin, entitiled “Reusable Optical Interface for Non-Permanent Passive Light Coupling”.

### SUMMARY

The invention may be implemented as an optical coupling system that includes a first optical element, a second optical element and a layer of optically transmissive elastic material disposed between the first optical element and the second optical element. At least one of the first optical element and the second optical element has a surface facing the elastic layer that is non-planar across the surface.

The invention may also be implemented as an optical element. The optical element includes a rigid body having a coupling surface that is non-planar across the surface.

Other aspects and advantages of the invention will become apparent from the following detailed description, taken in conjunction with the accompanying drawings, illustrating by way of example the principles of the invention.

### BRIEF DESCRIPTION OF DRAWINGS

The invention will be better understood with reference to the drawings, in which:

FIG. 1 is schematic exploded view of an optical biosensor system, based upon surface plasmon resonance (SPR), including an optical coupling system according to an embodiment of the invention;

FIG. 2 is an isometric drawing of a prism of the optical coupling system in FIG. 1, as viewed in the direction of arrow A in FIG. 1;

FIG. 3 is a cross sectional view of the optical coupling system in FIG. 1, as viewed in the direction of arrow B in FIG. 1;

FIG. 4 is a cross sectional view of an optical coupling system according to another embodiment of the invention;

FIG. 5 is a cross sectional view of an optical coupling system according to yet another embodiment of the invention;

FIG. 6 is an isometric view of an optical coupling system according to yet a further embodiment of the invention, the optical coupling system including a prism and a sensor unit having a respective optical coupling surface that is convex; and

FIG. 7 is a cross sectional view of the optical coupling system in FIG. 6 as viewed in the direction of an arrow C in FIG. 6.

### DETAILED DESCRIPTION OF THE EMBODIMENTS

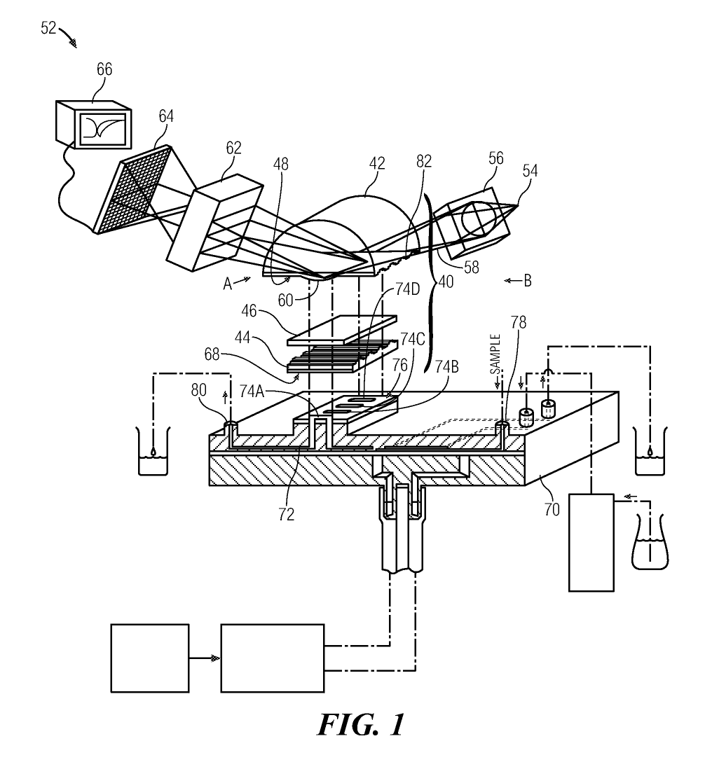

As shown in the drawings for purposes of illustration, the invention may be embodied in a novel optical coupling system. Some existing optical coupling systems suffer from poor coupling due to trapped air between an optical coupling element and an elastic coupling medium. Referring to FIGS. 1 to 7, an optical coupling system 40, 100 generally includes a first optical element in the form of a prism 42, 108 a second optical element in the form of a sensor unit 44, 104 and an optointerface layer 46 of at least optically translucent elastic material disposed between the prism 42, 108 and the sensor unit 44, 104. At least one of the prism 42, 108 and the sensor unit 44, 104 has a surface 48, 50 facing the optointerface layer 46 that is non-planar across the surface 48, 50. That is, the surface 48, 50, is non-planar from one side of the optical element to another side.

An optical biosensor system 52 that includes the abovedescribed optical coupling system 40 will next be described with the aid of FIG. 1. The optical biosensor system 52 includes a light source 54 and a light-focusing lens 56. The light-focusing lens 56 directs a transversely extending convergent beam 58 from the light source 54 toward the prism 42 whereby the beam 58 is focused on the bottom surface 68 of the sensor unit 44 to thus form a streak 60 of light at the sensor unit surface 68. The optointerface layer 46 allows the light to pass between the prism 42 and sensor unit 44 with little or no loss. Rays of light reflected from the surface 68 of the sensor unit 44 are imaged via an anamorphic lens system 62 onto a two-dimensional photodetector device 64. The electric signals created by the photodetectors 64 are captured and processed in a computing device 66 that functions as an evaluation device.

The undersurface 68 of the sensor unit 44 abuts a block unit 70 for liquid handling. The block unit 70 includes flow channels 72 (only one of which is shown). The flow channels 72 include respective sections 74A-74D that are exposed on an upward facing surface 76 of the block unit 70. More specifically, the sensor unit 44 abuts these upwardly open sections 74A-74D of the flow channels 72 to be optically coupled thereto. The undersurface 68 of the sensor unit 44 is thus exposed to the sample in the flow channels 72. Typically, the undersurface 68 is coated with a thin layer of metal to enable SPR sensing. The block unit 70 also includes an inlet connection means 78 and an outlet connection means 80. Such an optical biosensor system 52 is suitable for surface plasmon resonance (SPR) analysis in a continuous liquid stream. During use, a carrier (also known as buffer) solution is allowed to flow continuously through the flow channel 72. A sample solution is injected into the carrier solution via an injection valve (not shown). The analytes will bind to the metal coated undersurface 68 and will change the surface Plasmon resonance angle. The binding of analytes, measured in the form of SPR angular shift, from the sample solution onto the sensor unit 44 is monitored and a sensor gram is produced.

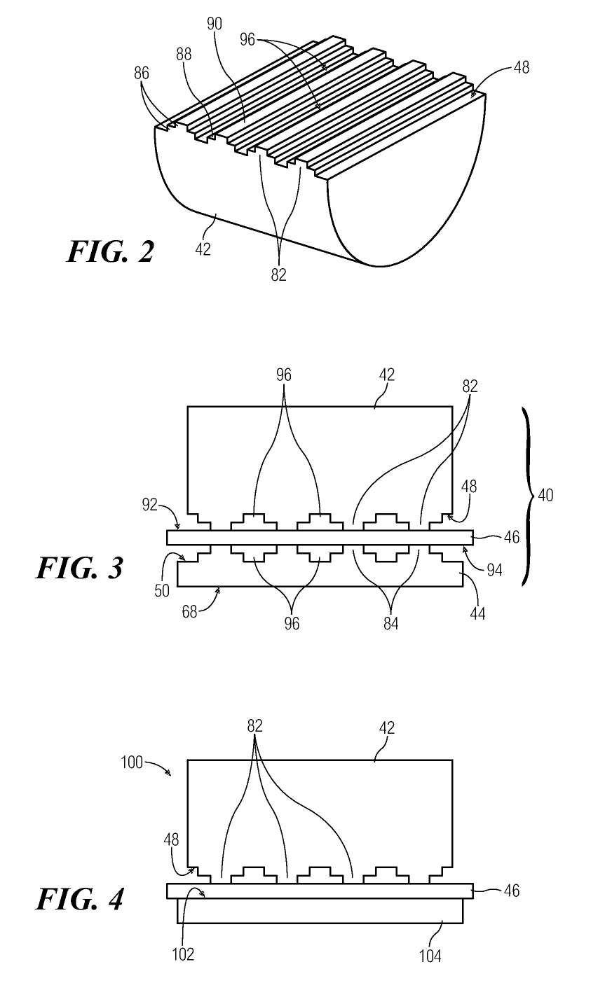

The prism 42 of the optical coupling system 40 is next described with the aid of FIGS. 1-3. The surface 48 of the prism 42 that faces the optointerface layer 46 is provided with surface protrusions. In this embodiment, the protrusions are elongated protrusions in the form of a number of longitudinally extending parallel ridges 82 in a side-by-side relationship. Each of these ridges 82 is pyramidal in form. The surface 50 of the sensor unit 44 that faces the optointerface layer 46 has a corresponding number of parallel longitudinal ridges 84 lying opposite the ridges 82 of the prism 42. That is, in this embodiment, both the surfaces 48, 50 of the prism 42 and the sensor unit 44 are non-planar across the respective surfaces 48, 50. The ridges 82, 84 are spaced apart a distance corresponding to the distance between the upwardly open sections 74A-74D of the flow channels 72. As will be seen more clearly from FIG. 2, the ridges 82, 84 have longitudinally extending stepped portions 86 at each side of the ridges 82, 84 to thus form a structure having in cross section the configuration of a flight of stairs. In other words, each of two opposing sides of the pyramidal protrusions includes at least one notch 88 to define the step portions 86 in the side. It should not be construed that the cross section of the ridges 82, 84 is limited to the flight of stairs configuration as shown in the figures; ridges of other cross sectional shapes are also possible. Cross sectional shapes such as trapezoidal, semi-circular, etc., are among those that may be employed. The uppermost step or top platform 90 of each of these stepped structures is capable of being pressed resiliently against the surfaces 92, 94 (FIG. 3) of the optointerface layer 46 to sealingly connect thereto. As the prism 42 and the sensor unit 44 are brought into contact with the optointerface layer 46, air is expelled from the contact surfaces laterally into channels 96 defined between the ridges 82, 84, as shown more clearly in FIG. 3. In other words, the surfaces 48, 50 are shaped to provide air escape paths across the surface 48, 50.

This stepped configuration thus prevents air pockets from being formed at the interfaces between the prism 42 and the sensor unit 44, and the respective surfaces 92, 94 of the optointerface layer 46. FIG. 3 shows the prism 42, the optointerface plate 46 and the sensor unit 44 sealingly connected in the analysis position of the biosensor system 52 in FIG. 1 after having been brought together.

This arrangement of the ridges 82, 84 on the prism surface 48 and the sensor unit surface 50, in accurate registration over the upwardly open sections 74A-74D of the block unit 70 ensures that the lower ridges 84 will serve as sources of light which lie directly above each of the corresponding channel sections 74A-74D. No scattered light from neighboring ridges 84 will interfere with the resonance angle determination for the individual sensing areas of the sensing unit 44 over each channel section 74-74D. In this manner it is possible to have a large number of these channel sections 74-74D packed next to one another. As an example, it is possible to have twenty of such upwardly open channel sections 74-74D packed side-by-side across a distance of about 10 mm without any scattered light interfering with the measuring operation.

The prism 42 and the sensor unit 44 are of rigid bodies that may be made of borosilicate glass and shaped to define the ridges 82, 84 using a variety of methods such as molding, polishing, etching and micro fabrication techniques. For the described application the ridges 82, 84 on the prism surface 48 and the sensor unit surface 50 may, for example, have a length of about 7 mm, a width of about 700 μm and a height (or thickness) of about 100 μm.

The optointerface layer 46 in this embodiment has substantially the same refractive index as the prism 42 and sensor unit 44. The optointerface layer 46 may be made of elastic material such as silicone rubber, polybutadiene, epoxy resin or the like. A silicone rubber having nearly the same refractive index as borosilicate glass (nₑ=1.52) is that of the commercial designation Dow Corning Optigard X3-6663 Optical fiber coating (nₑ=1.51). In other embodiments, the refractive index of the optointerface layer 46 may be different from the refractive indices of the prism 42 and the sensor unit 44. The difference that is tolerable depends on the application and specific engineering design. The optointerface layer 46 is optically transmissive. In other words, the optointerface layer 46 may be translucent or transparent but not opaque. That is, the optointerface layer 46 may be partially light absorbing.

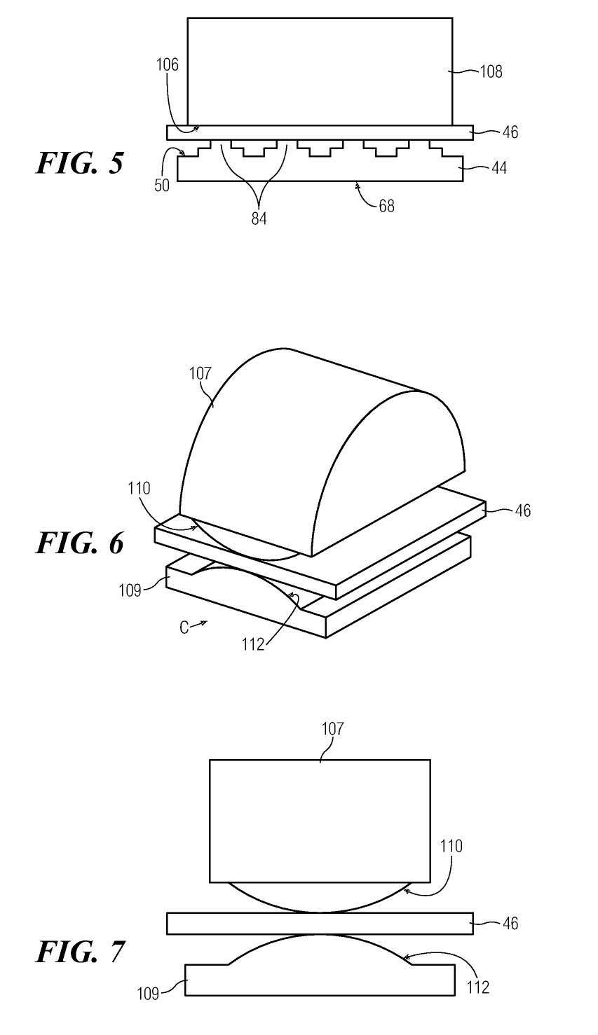

Although the present invention is described as implemented in the specific embodiment for use in an optical biosensor system 52, it is not to be construed to be limited as such in its structure or application. Many variations and modifications in its structure are possible. As an example, the invention may be implemented in an embodiment with dimensions that differ from those given in the above description. As another example, FIG. 4 shows a cross sectional view of an optical coupling system 100 according to another embodiment of the invention. In this embodiment, the optointerface layer 46 is fixedly attached to a planar surface 102 of a sensor unit 104; only the prism surface 48 includes the ridges 82 as described above. An optointerface material is deposited on the planar surface 102 of the sensor unit 104 in a manner that avoids trapping air at the surface 102. For example, the optointerface material may be a liquid or gel that is deposited on the planar surface 102 and cured. Alternatively, the optointerface layer 46 may be adhered to the surface 102 in such a manner that subsequent mechanical pressing of the optointerface layer 46 will expel any air bubbles that are trapped in between the optointerface layer 46 and the sensor unit 104. During use, air is expelled as described above when the ridged surface 48 of the prism 42 is brought into contact with the optointerface layer 46. Alternatively, as shown in FIG. 5, the optointerface layer 46 may be fixedly attached to a planar surface 106 of a prism 108, leaving ridges 84 only on the surface 50 of the sensor unit 44. As yet another example, a prism 107 and a sensor unit 109 including respective convex surfaces 110, 112 as shown in FIGS. 6 and 7 may be used instead of the prism 42 and the sensor unit 44 with ridges 82, 84 on respective surfaces 48, 50. In other words, each of the prism 107 and the sensor unit 109 may have an arcuate light coupling surface. As mentioned above, it is possible for only one of these two surfaces 110, 112 to be convex, the other surface 110, 112 may be planar. Unlike the planar light coupling surface in the prior art which comes into contact with the optointerface layer 46 entirely all at once, the convex surface 110, 112 comes into contact with the optointerface layer 46 only increasingly. In this manner, air at the interface is allowed to escape as the convex surface 110, 112 is brought into increasing contact with the optointerface layer 46.

With regard to applications, the optical coupling system 40 is not limited to the SPR application described above for coupling a prism 42 to a sensor unit 44. The optical coupling system may be applied to other conceivable measurement applications requiring the non-permanent optical coupling of one optical element to another. The optical coupling system is especially valuable to all optical measurements employing total internal reflection inside a removable optical element and a stationary optical element used for coupling light into the removable element. For example, Internal Reflection Spectroscopy (IRS) is a potential application, which includes infrared spectroscopy and fluorescence spectroscopy. Another application is in light coupling to/from light-wave guiding units for communication and/or detection, and for light coupling to/from light conducting units for transmission, reflection, light scattering and absorbance measurements. Another use of the optical coupling system is in optical grating couplers. Hence, the optointerface may be used to couple light between a first planar waveguide and a second planar waveguide or transparent plate that is provided with a grating region.

What is claimed is:

1. An optical coupling system comprising:
a first optical element;
a second optical element; and
a layer of an optically transmissive elastic material disposed between the first optical element and the second optical element;
at least one of the first optical element and the second optical element having a surface facing the elastic layer that is non-planar across the surface.

2. An optical coupling system according to claim 1, wherein each of the first optical element and the second optical element has a surface facing the elastic layer that is non-planar across the surface.

3. An optical coupling system according to claim 1, wherein the surface comprises protrusions.

4. An optical coupling system according to claim 3, wherein the protrusions comprise elongated protrusions.

5. An optical coupling system according to claim 4, wherein the elongated protrusions comprises elongated protrusions that are at least substantially parallel.

6. An optical coupling system according to claim 3, wherein the protrusions are pyramidal in form.

7. An optical coupling system according to claim 6, wherein each of two opposing sides of the pyramidal protrusions includes at least one notch to define a step in the side.

8. An optical coupling system according to claim 3, wherein the protrusions have one of a trapezoidal and a semi-circular cross section.

9. An optical coupling system according to claim 1, wherein the surface comprises a convex surface.

10. An optical coupling system according to claim 1, wherein the elastic layer comprises a flat elastic layer.

11. An optical coupling system according to claim 10, wherein the surface of one of the first optical element and the second optical element is non-planar across the surface and the other surface of the first optical element and the second optical element is planar and is fixedly attached to the elastic layer.

12. An optical element comprising:
a rigid body having a light coupling surface that is non-planar across the surface.

13. An optical element according to claim 12, wherein the surface comprises protrusions.

14. An optical element according to claim 13, wherein the protrusions comprise elongated protrusions.

15. An optical element according to claim 14, wherein the elongated protrusions comprises elongated protrusions that are at least substantially parallel.

16. An optical element according to claim 13, wherein the protrusions are pyramidal in form.

17. An optical element according to claim 16, wherein each of two opposing sides of the pyramidal protrusions includes at least one notch to define a step in the side.

18. An optical element according to claim 13, wherein the protrusions have one of a trapezoidal and a semi-circular cross section.

19. An optical element according to claim 12, wherein the surface comprises a convex surface.
